(19) United States
(12) Patent Application Publication
(10) Pub. No.: US 2025/0005549 A1
(43) Pub. Date: Jan. 2, 2025

(54) OBJECT IDENTIFICATION BASED ON A PARTIAL VISUAL OBJECT IDENTIFIER CODE SCAN AT POINT OF SALE

(71) Applicant: Toshiba Global Commerce Solutions, Inc., Durham, NC (US)

(72) Inventor: Matthew Earl Slessman, Raleigh, NC (US)

(21) Appl. No.: 18/217,282

(22) Filed: Jun. 30, 2023

(51) Int. Cl. G06Q 20/20

(52) U.S. Cl. CPC G06Q 20/208

(57) ABSTRACT

Systems and methods of object identification based on a partial visual object identifier code at point of sale are provided. In one exemplary embodiment, a method is performed by a POS system having a first optical sensor operable to scan visual object identifier codes disposed on objects. Each code represents one of a set of object identifiers. Further, each identifier is specific to a certain object and is represented by a series of characters. The method includes obtaining, based on a scan performed by the first optical sensor of one of the visual object identifier codes disposed on a certain object, a portion of the series of characters that represents a corresponding object identifier so that the certain object can be selected or identified based on the set of object identifiers and the portion of the series of characters that represents the corresponding object identifier.

### BACKGROUND

Retailers use point of sale (POS) hardware and software systems to streamline checkout operations and to allow retailers to process sales, handle payments, and store transactions for later retrieval. Each POS system generally includes a number of components including a POS terminal station device and a POS bagging station device. POS bagging station devices can enable customers or retail staff to bag purchased retail items in shopping bags during checkout at the POS systems. POS terminal station devices can include a computer, a monitor, a cash drawer, a receipt printer, a customer display, a barcode scanner, or a debit/credit card reader. POS systems can also include a conveyor belt, a checkout divider, a weight scale, an integrated credit card processing system, a signature capture device, or a customer pin pad device. While POS systems may include a keyboard and mouse, more and more POS monitors use touchscreen technology. The POS software can be configured to handle a myriad of customer based functions such as sales, returns, exchanges, layaways, gift cards, gift registries, customer loyalty programs, promotions, and discounts. In a retail environment, there can be multiple POS systems in communication with a server over a network.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1 illustrates one embodiment of a system operable to perform object identification based on a partial visual object identifier code scan at point of sale in accordance with various aspects as described herein.

FIG. 2 illustrates one embodiment of a POS system in accordance with various aspects as described herein.

FIG. 3A illustrates another embodiment of a POS system in accordance with various aspects as described herein. FIG. 3B illustrates one embodiment of a network node in accordance with various aspects as described herein.

FIG. 4A-E illustrate embodiments of a method performed by a POS system of object identification based on a partial visual object identifier code scan at point of sale with various aspects as described herein.

FIG. 5 illustrates another embodiment of a POS system in accordance with various aspects as described herein.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details.

In the retail environment, a barcode disposed on a retail item can be damaged, folded, concealed, hidden, faded, scratched, or the like such that a barcode scanner is unable to obtain a Universal Product Code (UPC) from a scan of the barcode at the point of sale. Instead, a consumer or a retail store clerk would then be required to replace the retail item with another retail item having the same barcode/UPC, request a price lookup of that retail item, manually search for the retail item on a touchscreen display of the POS system, manually enter the UPC via the POS system, or the like. Accordingly, there is a need for improved techniques to use a portion of a UPC obtained from a barcode scan to determine the corresponding retail item. In addition, other desirable features and characteristics of the present disclosure will become apparent from the subsequent detailed description and embodiments, taken in conjunction with the accompanying figures and the foregoing technical field and background.

In one exemplary embodiment, a barcode scanner of a POS system can be operable to scan a barcode disposed on a certain retail item to obtain a portion of the UPC and can then determine those candidate retail items that have that same portion of the UPC based on a UPC database with each UPC having a manufacturer name, a retail item name, retail item image, barcode, UPC identifier, retail item description, available quantity, a range of potential weights, the like, or any combination thereof. All or a portion of the UPC database can be stored in memory of the POS system or stored in memory of a network node that is communicatively coupled to the POS device over a network (e.g., Ethernet, Internet). The POS system can output, for display to a touchscreen display of the POS system, an image of each candidate retail item so that the consumer or the retail store clerk can select the retail item on the touchscreen from the displayed candidate retail items that corresponds to the certain retail item.

In another exemplary embodiment, the consumer can select the retail item on the touchscreen from the displayed candidate retail items that correspond to the portion of the UPC of the certain retail item. In response to the selection, the POS system can send, by a processing circuit of the POS system, to a light emitting device (LED) of the POS system, an indication to enable the LED. With the LED illuminated, a retail store clerk in the vicinity of the POS system can be visually alerted by the illuminated LED and in response, verify the consumer's selection of the certain retail item at the POS system.

In another exemplary embodiment, the consumer can select the retail item on the touchscreen from the displayed candidate retail items that correspond to the portion of the UPC of the certain retail item. In response to the selection, the POS system can send, to a network node over a network, an indication that includes a request to verify the consumer's selection of the certain retail item at the POS system. The network node can receive the request indication and in response, send, by processing circuitry of the network node, for display on a touchscreen of the network node, a visual representation that includes the request to verify the consumer's selection of the certain retail item at the POS system. A retail store clerk can view the verification request on the touchscreen and in response, verify the consumer's selection of the certain retail item on the touchscreen at the network node or at the POS system.

In another exemplary embodiment, the consumer can select the retail item on the touchscreen from the displayed candidate retail items that correspond to the portion of the UPC of the certain retail item. In response to the selection, the POS system can send, to a network node over a network, an indication that includes a request to verify the consumer's selection of the certain retail item at the POS system, with the indication including image data that represents an image of the certain retail item captures by an optical sensor of the POS system and image data that represents an image of the selected retail item. The network node can receive the request indication and in response, send, by processing circuitry of the network node, for display on a display of the network node, an indication that includes the request to verify the consumer's selection of the certain retail item at the POS system and visual representations of the image of the selected retail item and the image of the certain retail item. A retail store clerk can view the verification request and the displayed images and in response, verify the consumer's selection of the certain retail item at the network node or at the POS system.

In another exemplary embodiment, the POS system can receive, by a processing circuit of the POS system, from a load sensor (e.g., scanner scale) of the POS system, an indication that includes a weight measurement of the certain retail item. The POS system can then determine that the measured weight of the certain retail item corresponds to a range of potential weights associated with one of the candidate retail items based on a database of retail items with each retail item having a retail item name, retail item image, barcode, UPC identifier, retail item description, available quantity, a range of potential weights, the like, or any combination thereof. All or a portion of the retail item database can be stored in memory of the POS system or stored in memory of a network node that is communicatively coupled to the POS device over a network (e.g., Ethernet, Internet).

Another desirable feature and characteristic of the present disclosure includes a need for improved techniques to reduce the computational complexity in applying artificial intelligence for object identification. The computational complexity in applying artificial intelligence for object identification increases dramatically as the set of objects that can be identified increases. For a retailer having thousands of products, the use of artificial intelligence for object identification may not be practical due to the time, energy, cost, or performance required to identify an object.

In one exemplary embodiment, the POS system can receive, from an image sensor of the POS system, image data that represents an image of the certain retail item. The POS system can send, to an artificial intelligence circuit of the POS system, an indication that includes the image data of the certain retail item. The artificial intelligence circuit can be operable to perform object detection, classification, or identification of a retail item captured in an image. Further, the artificial intelligence circuit can be trained on image data of retail items such as all or a portion of retail items available from or sold in a retail store. In response, the artificial intelligence circuit can send, to the POS system, an indication that includes one or more predicted retail items and their confidence levels. The POS system can then identify the certain retail item based on the one or more predicted retail items and their confidence levels, and the candidate retail items that correspond to the certain retail item. In one example, the POS system can determine that the certain retail item corresponds to one of the one or more predicted retail items to identify the certain retail item. In another example, the POS system can determine that the certain retail item corresponds to one of the one or more predicted retail items and that the confidence level of that predicted retail item is above a certain confidence level threshold (e.g., 50%, 60%, 70%, 80%, 90%, 95%, 99%) so as to identify the certain retail item.

In another exemplary embodiment, the POS system can receive, from an image sensor of the POS system, image data that represents an image of the certain retail item. The POS system can send, to a network node over a network, an indication that includes the image data of the certain retail item. The network node can receive that indication and in response, send, to an artificial intelligence circuit of the network node, an indication that includes the image data of the certain retail item. The artificial intelligence circuit can be operable to perform object detection, classification, or identification of a retail item captured in an image. Further, the artificial intelligence circuit can be trained on image data of retail items such as all or a portion of retail items available from or sold in a retail store. In response, the artificial intelligence circuit can send, to the network node, an indication that includes one or more predicted retail items and their confidence levels. The network node can then send, to the POS system, an indication that includes the one or more predicted retail items and their confidence levels. The POS system can then identify the certain retail item based on the one or more predicted retail items and their confidence levels, and the candidate retail items that correspond to the certain retail item.

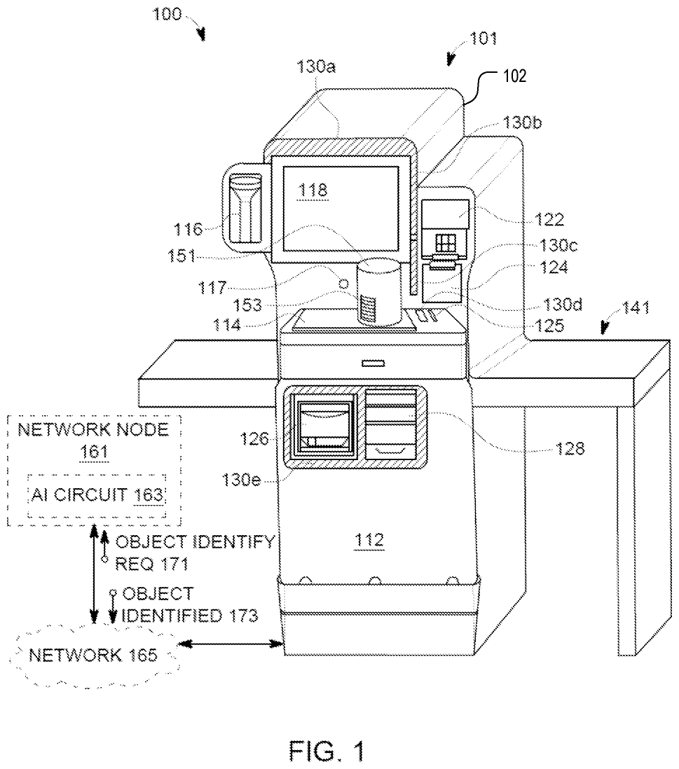

FIG. 1 illustrates one embodiment of a system 100 operable to perform object identification based on a partial visual object identifier code scan at point of sale in accordance with various aspects as described herein. As shown in FIG. 1, the system 100 includes the POS system 101 (e.g., checkout device, self-checkout device) communicatively coupled to a network node 161 (e.g., server) over a network 165 (e.g., Ethernet, WiFi, Internet). The POS system 101 can include a terminal station device 102 and a bagging station device 141. The terminal station device 102 has a housing 112, one or more optical scanners 114, 116, a display device 118, a payment processing mechanism 122, a printer 124, a coupon slot mechanism 125, a cash acceptor mechanism 126, a change interface mechanism 128, the like, or any combination thereof. In addition, the terminal station device 102 can be configured to include a set of light emitting element (LED) devices 130a-e (collectively, LED devices 130). The housing 112 can be configured to include a cabinet that contains a processing circuit operable to control the operations and functions of the POS system 101. Each LED device 130a-e can be configured to be individually or collectively controlled by a processing circuit of the POS system 101 to indicate certain contextual information to a consumer or a retail store clerk. Although not explicitly shown herein, the housing 112 can also contain cabling and other functional components that communicatively couple the POS system 101 to the network 165 (e.g., Ethernet, WiFi, Internet) or the network node 161 (e.g., server) over the network 165 or that communicatively couple the terminal station device 102 to the bagging station device 141. The network node 161 may include, for example, one or more server devices that may or may not be co-located with the POS system 101 or in the retail store that includes the POS system 101.

In FIG. 1, each scanner 114, 116 can be configured as an optical scanner operable to scan a visual object identifier code 153 (e.g., barcode, QR code) disposed on an object 151 (e.g., retail item) that a consumer intends to purchase via the POS system 101. Each visual object identifier code 153 can represent one of a set of object identifiers (e.g., UPCs), with each identifier being specific to a certain object (e.g., retail item, trade item) and represented by a series of characters (e.g., numeric characters, alphabetic characters, alphanumeric characters). Universal Product Code (UPC), which technically refers to UPC-A, consists of a sequence of twelve characters (e.g., 12 numeric characters) that are uniquely assigned to each trade item (e.g., retail item). Along with the related International Article Number (EAN) barcode, the UPC is the barcode mainly used for scanning of trade items at the point of sale, per the specifications of the international GS1 organization. In one example, a UPC-A barcode consists of a sequence of twelve characters (e.g., 12 digits), which are made up of four sections: a number system character, a five-character manufacturing number, a five-character item number and a check character.

The scanner 116 can be configured as a hand-held, battery-operated scanner that a consumer or a clerk can remove from its battery charging dock to scan barcodes on retail items such as without having to remove them from a shopping cart. For those situations where the visual object identifier code 153 disposed on the object 151 is damaged, folded, creased, concealed, hidden, faded, scratched, or the like, the scanner 114, 116 is operable to scan the damaged visual object identifier code 153 to obtain a portion of the series of characters of the object identifier. In one example, the portion of the series of characters can include characters at a first position and a last position of the series of characters, with one or more positions between the first and last positions of the series of characters corresponding to unscanned, undetected or undecoded characters of the series of characters. In another example, one or more positions of the series of characters that start at the first position or end at the last position of the series of characters corresponds to unscanned, undetected or undecoded characters of the series of characters.

In FIG. 1, the scanner 114 can be operable to perform dual scanner and scale functions to allow the retail item to be contemporaneously scanned and weighed for purchase by a consumer. The display 118 can be operable to display information associated with retail items being purchased by a consumer. The payment processing mechanism 122 can be configured with a pinpad device operable to accept a non-cash payment vehicle (e.g., credit card or debit card), while the printer 124 can be configured to print receipts or coupons. The coupon slot mechanism 125 can include a generally elongated slot configured to receive coupons being redeemed by a consumer. The cash acceptor mechanism 126 can be operable to receive cash (e.g., paper money, coins) from the consumer for the retail items being purchased by the consumer. The change interface mechanism 128 can be operable to provide change to the consumer in the form of paper money or coins. The terminal station device 102 can also include a second sensor 117 (e.g., optical sensor, camera) operable to capture an image of an object on or about the surface of the optical scanner 114. The field of detection of the second sensor 117 can be towards the certain region on or about the surface of the optical scanner 114.

In operation, the POS system 101 can obtain, based on a scan performed by the first optical sensor 114, 116 of the visual object identifier code 153 (e.g., barcode, QR code) disposed on the certain object 151 (e.g., retail item, trade item, a portion of the series of characters that represents the object identifier (e.g., UPC) of the visual object identifier code 153. The POS system 101 can obtain those object identifiers of the set of object identifiers (e.g., UPC database) that correspond to the portion of the series of characters of the object identifier of the certain object 151 to obtain candidate object identifiers. The POS system 101 can identify the certain object 151 based on the candidate object identifiers. The POS system 101 can send to the network node 161 over the network 165 (e.g., Ethernet, Internet), an indication associated with the identification of the certain object 151 so that the identification of the certain object 151 can be verified.

In another embodiment, the POS system 101 can receive, from the first optical sensor 114, 116, image data that represents an image or a scan of the visual object identifier code 153 of the certain object 151. Further, the POS system 101 can decode the visual object identifier code 153, based on the image data, to obtain the portion of the series of characters that represents the object identifier of the certain object 151.

In another embodiment, the POS system 101 can determine those object identifiers of the set of object identifiers that correspond to the portion of the series of characters of the object identifier of the certain object 151 as those having the same characters in the same positions or order as the portion of the series of characters of the object identifier of the certain object 151.

In another embodiment, the POS system 101 can determine those object identifiers of the set of object identifiers that correspond to the portion of the series of characters to obtain candidate object identifiers. Further, the POS system 101 can obtain images of those objects that are specific to the candidate object identifiers (such as from a retail item database) to obtain candidate object images. The POS system 101 can output, for display on the display 118, a visual representation associated with a request to select one of the candidate objects based on the visual representations of the candidate object images. In response, the POS system 101 can receive, from the display 118, an indication of a touch gesture detected at or about the visual representation associated with one of the candidate object images. The POS system 101 can determine that the detected touch gesture corresponds to that one candidate object image to obtain a selected object. The POS system 101 can then identify the certain object 151 as the selected object.

In another embodiment, the POS system 101 can send, to the network node 161 over the network 165, an indication associated with a request to verify an object at the POS system 101. Further, the POS system 101 can output, for display on the presence sensitive display 118, a visual representation associated with a request to verify that the certain object 151 is the one of the candidate objects (e.g., selected object). The network node 161 can receive the indication and in response, can obtain the request to verify the certain object 151 from the indication. The network node 161 can then determine to perform the request to verify the certain object 151 at the POS system 101 by, for instance, outputting, to a presence sensitive display of the network node 161, a visual representation associated with the request to verify an object at the POS system 101. A retail store clerk can view, on the presence sensitive display of the network node 161, the visual representation of the verification request at the POS system 101 and in response, can walk to the POS system 101. While at the POS system 101, the retail store clerk can view the visual representation associated with the request to verify that the certain object 151 is the one of the candidate objects. The POS system 101 can receive, from the display 118, an indication of a touch gesture detected at or about the visual representation of the verify request. The POS system 101 can then verify that the certain object 151 is the one of the candidate objects based on the detected touch gesture.

In another embodiment, the POS system 101 receives, from the second optical sensor 117, image data that represents an image of the certain object 151. In one example, the POS system 101 can send, to the second optical sensor 117, an indication to capture the image data that represents the image of the certain object 151 contemporaneous with the first optical sensor 114 scanning the visual object identifier code 153 disposed on the certain object 151. In another example, the POS system 101 can send, to the second sensor 117, an indication to capture the image data that represents the image of the certain object 151 responsive to determining that the scan of the visual object identifier code 153 resulted in a portion of the series of characters of the corresponding object identifier. The POS system 101 can then send, to the network node 161 over the network 165, an indication 171 that includes a request to identify whether the certain object 151 corresponds to the selected object based on the included image data of the certain object 151 and image data of the selected object. The network node 161 can output, for display on a presence sensitive display of the network node 161, a visual representation of a request to verify the certain object 151 and the image data of the certain object 151 and the image data of the selected object. A retail store clerk can verify that the certain object 151 corresponds to the selected object by a touch gesture on the display of the network node 151. The network node 161 can receive, from the display, an indication of a touch gesture detected at or about the visual representation of the verification request. The network node 161 can determine that the detected touch gesture corresponds to the visual representation of the verification request and in response, can determine that the certain object 151 is identified as the selected object. The network node 161 can then send, to the POS system 101 over the network 165, an indication 173 that the certain object 151 is identified as the selected object. The POS system 101 can receive the object identified indication 173 and in response, identify the certain object 151 as the selected object.

In another exemplary embodiment, the POS system 101 can receive, from the second optical sensor 117 of the POS system 101, image data that represents an image of the certain retail item 151. The POS system 101 can send, to the network node 161 over the network 165, an indication 171 that includes a request to identify the certain object 151 that includes the image data of the certain object 151. The network node 161 can receive that indication 171 and in response, can send, to an artificial intelligence circuit 163 of the network node 161, an indication that includes the image data of the certain retail item 151. The artificial intelligence circuit 163 can be operable to perform object detection, classification, or identification of an object displayed in an image. Further, the artificial intelligence circuit 163 can be trained on image data of the sets of objects such as all or a portion of retail items available from or sold in a retail store. In response, the artificial intelligence circuit 163 can send, to the network node 161, an indication that includes one or more predicted objects and their confidence levels. The network node 161 can then send, to the POS system 101 over the network 165, an indication that includes the one or more predicted objects and their confidence levels. The POS system 101 can receive this indication and in response, can identify the certain retail item based on the one or more predicted retail items and their confidence levels and the candidate objects that are specific to the candidate object identifiers.

In another embodiment, the first and second optical sensors are the same sensor.

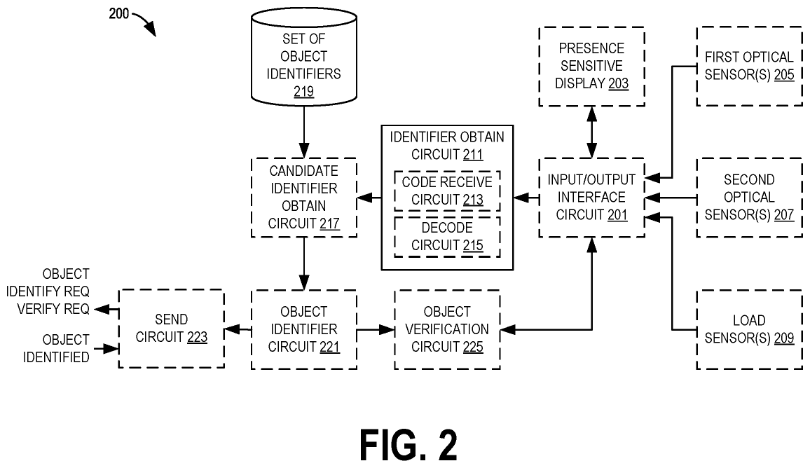

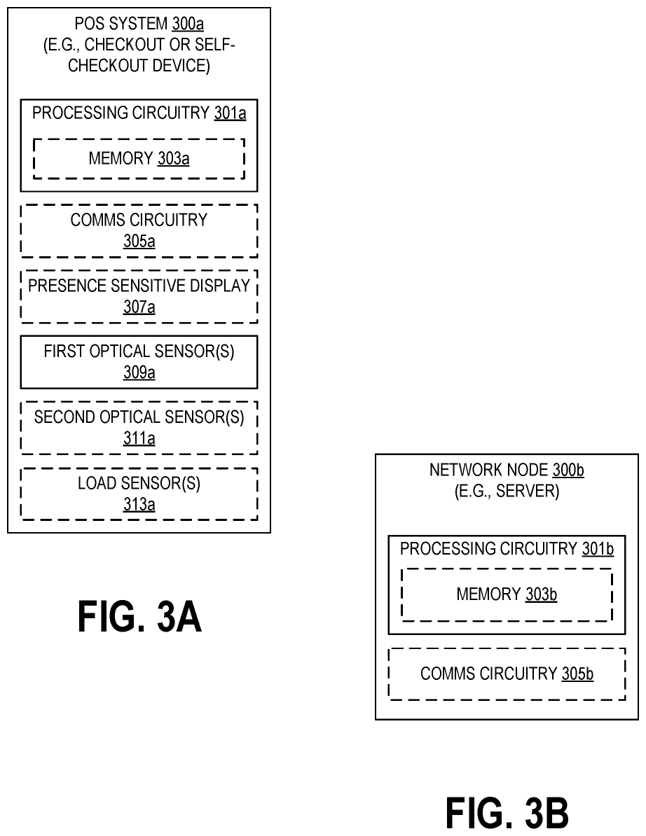

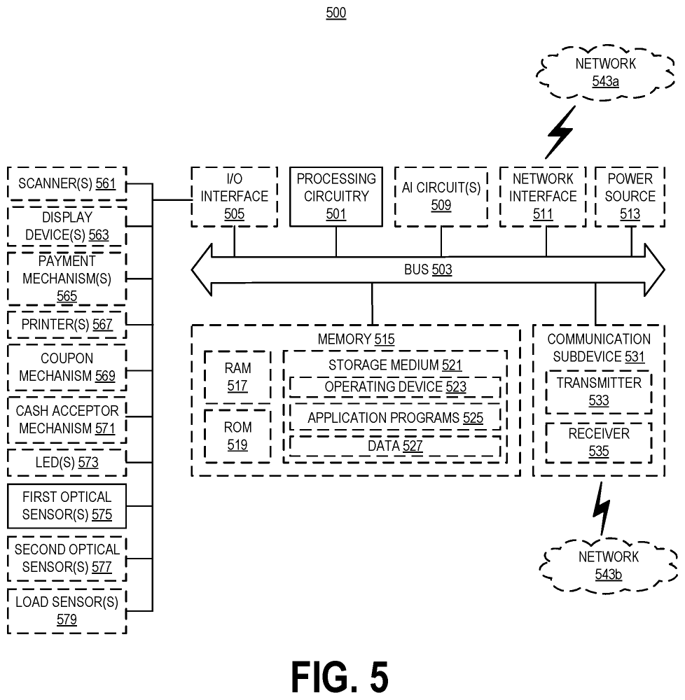

FIG. 2 illustrates one embodiment of a POS system 200 in accordance with various aspects as described herein. In FIG. 2, the device 200 implements various functional means, units, or modules (e.g., via the processing circuitry 301a in FIG. 3A, via the processing circuitry 501 in FIG. 5, via software code, or the like), or circuits. In one embodiment, these functional means, units, modules, or circuits (e.g., for implementing the method(s) described herein) may include for instance: an input/output interface circuit 201 operable to communicate with input/output devices such as a presence sensitive display 203 (e.g., touchscreen), a first optical sensor 205 (e.g., scanner), a second optical sensor 207 (e.g., camera), a load sensor 209 (e.g., weight sensor), the like, or any combination thereof; an object identifier obtain circuit 211 operable to obtain, based on a scan performed by the first or second optical sensor 205, 207 of a visual object identifier code disposed on a certain object, all or a portion of a series of characters that represents a corresponding object identifier of that visual object identifier code; a visual object identifier code receive circuit 213 operable to receive, based on a scan performed by the first or second optical sensor 205, 207 of a visual object identifier code disposed on a certain object, image data that corresponds to an image of a visual object identifier code disposed on a certain object; a visual object identifier code decode circuit 215 operable to decode image data that corresponds to an image of a visual object identifier code disposed on a certain object to obtain all or a portion of an object identifier represented by a sequence of characters; a candidate object identifier obtain circuit 217 operable to obtain those object identifiers of a set of object identifiers 219 that corresponds to a portion of the sequence of characters of an object identifier to obtain candidate object identifiers; an object identifier circuit 221 operable to identify the certain object based on the candidate object identifiers; a send circuit 223 operable to send information; an object verification circuit 225 operable to verify the certain object.

FIG. 3A illustrates another embodiment of a POS system 300a in accordance with various aspects as described herein. In FIG. 3A, the device 300a may include processing circuitry 301a that is operably coupled to one or more of the following: memory 303a, network communications circuitry 305a, a presence sensitive display 307a, a first optical sensor 309a (e.g., scanner), a second optical sensor 309a (e.g., camera), one or more second sensors 311a (e.g., presence, proximity or motion sensor), a load sensor 313a (e.g., weight sensor), the like, or any combination thereof. The network communication circuitry 305a is configured to transmit or receive information to or from one or more other devices via any communication technology. The processing circuitry 301a is configured to perform processing described herein, such as by executing instructions stored in memory 303a. The processing circuitry 301a in this regard may implement certain functional means, units, or modules.

FIG. 3B illustrates another embodiment of a network node device 300b in accordance with various aspects as described herein. In FIG. 3B, the device 300b may include processing circuitry 301b that is operably coupled to one or more of the following: memory 303b and network communications circuitry 305b, the like, or any combination thereof. The network communication circuitry 305b is configured to transmit and/or receive information to and/or from one or more other network node devices via any communication technology. The processing circuitry 301b is configured to perform processing described herein, such as by executing instructions stored in memory 303b. The processing circuitry 301b in this regard may implement certain functional means, units, or modules.

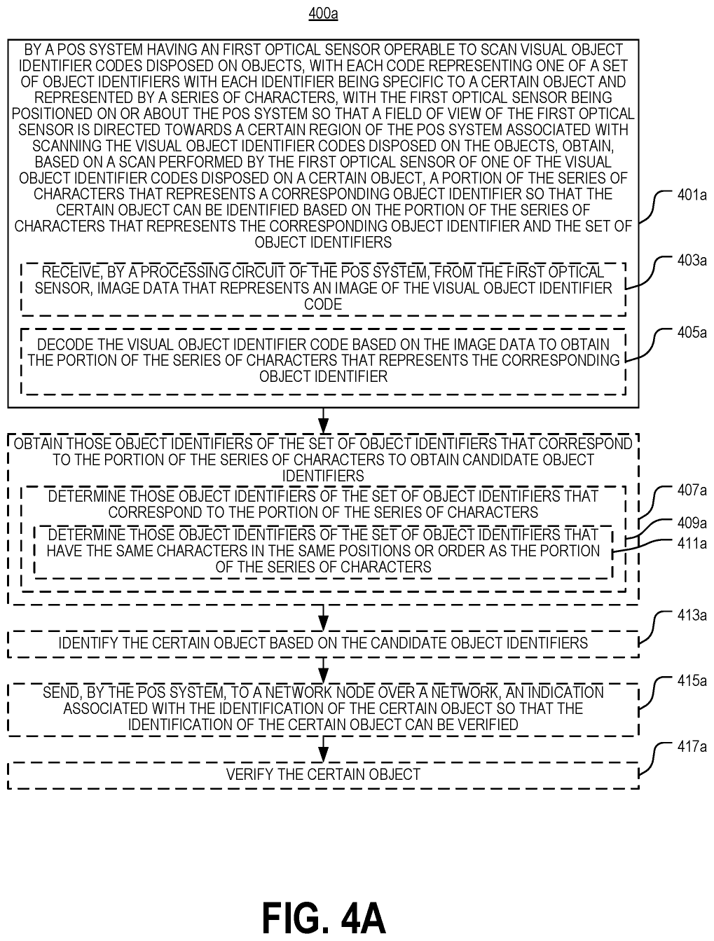

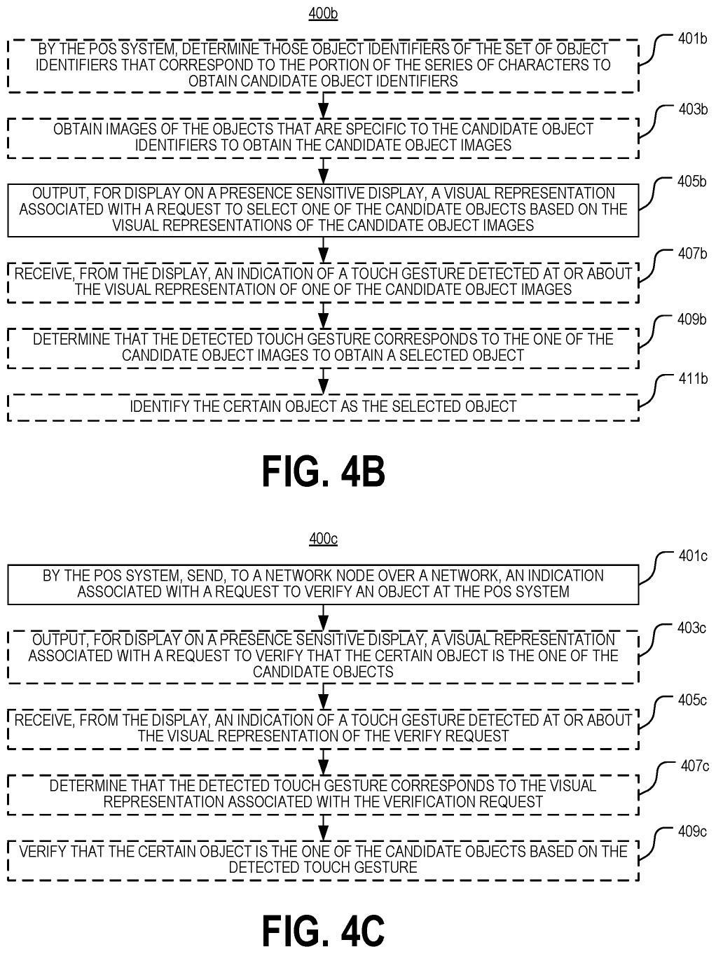

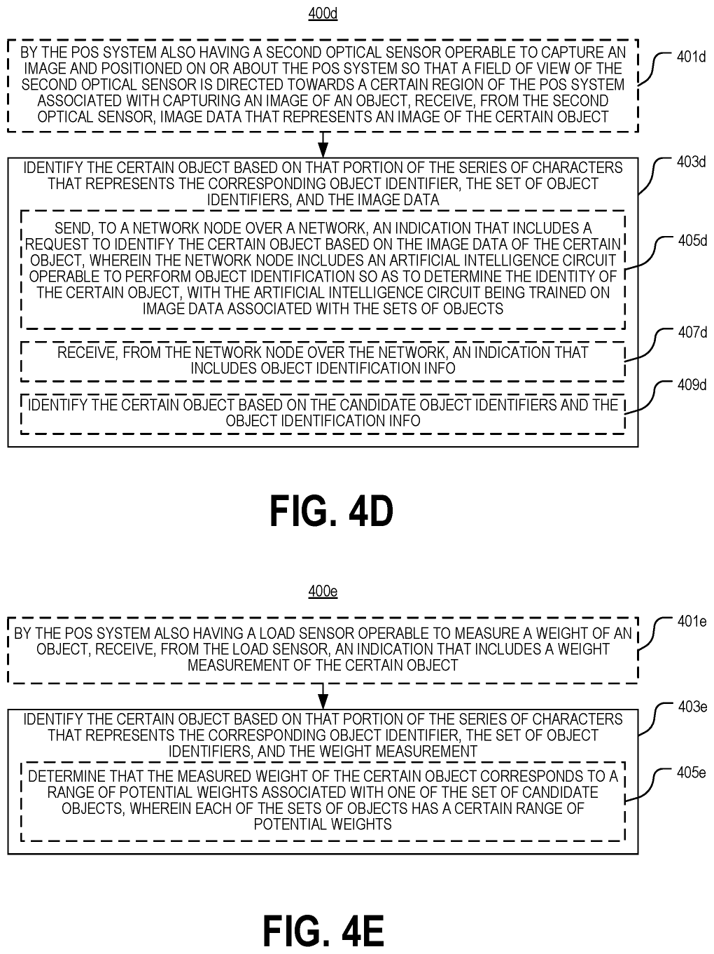

FIG. 4A illustrates one embodiment of a method 400a performed by a POS system 101, 200, 300a, 500 of object identification based on a partial visual object identifier code scan at point of sale in accordance with various aspects as described herein. In FIG. 4A, the method 400a may start, for instance, at block 401a where it includes obtaining, based on a scan performed by the first optical sensor of one of the visual object identifier codes disposed on a certain object, a portion of the series of characters that represents a corresponding object identifier so that the certain object can be selected based on the portion of the series of characters that represents the corresponding object identifier and the set of object identifiers. At block 403a, the method 400a may include receiving, by a processing circuit of the POS system, from the first optical sensor, image data that represents an image of the visual object identifier code. The method 400a may include decoding the visual object identifier code based on the image data to obtain the portion of the series of characters that represents the corresponding object identifier, as referenced at block 405a. At block 407a, the method 400a may include determining those object identifiers of the set of object identifiers that correspond to the portion of the series of characters to obtain candidate object identifiers. The method 400a may include determine those object identifiers of the set of object identifiers that correspond to the portion of the series of characters, as represented at block 409a. At block 411a, the method 400a may include determining those object identifiers of the set of object identifiers that have the same characters in the same positions or order as the portion of the series of characters. At block 413a, the method 400a may include identifying the certain object based on the candidate object identifiers. The method 400a may include sending, by the POS system, to a network node over a network, an indication associated with the identification of the certain object so that the identification of the certain object can be verified, as represented at block 415a. At block 417a, the method 400a may verify the certain object.

FIG. 4B illustrates another embodiment of a method 400b performed by a POS system 101, 200, 300a, 500 of object identification based on a partial visual object code scan at point of sale in accordance with various aspects as described herein. In FIG. 4B, the method 400b may start, for instance, at block 401b where it may include determining those object identifiers of the set of object identifiers that correspond to the portion of the series of characters of the object identifier of the certain object to obtain candidate object identifiers. At block 403b, the method 400b may include obtaining images of the objects that are specific to the candidate object identifiers to obtain the candidate object images. At block 405b, the method 400b includes outputting, for display on the display, a visual representation associated with a request to select one of the candidate objects based on visual representations of the candidate object images. The method 400b may include receiving, from the display, an indication of a touch gesture detected at or about the visual representation of one of the candidate object images, as represented at block 407b. At block 409b, the method 400b may include determining that the detected touch gesture corresponds to the one of the candidate object images to obtain a selected object. At block 411b, the method 400b may include identifying the certain object as the selected object.

FIG. 4C illustrates another embodiment of a method 400c performed by a POS system 101, 200, 300a, 500 of object identification based on a partial visual object code scan at point of sale in accordance with various aspects as described herein. In FIG. 4C, the method 400c may start, for instance, at block 401c where it includes sending, to a network node over a network, an indication associated with a request to verify that the certain object is one of the candidate objects. At block 403c, the method 400c can include outputting, for display on the presence sensitive display, a visual representation associated with a request to verify that the certain object is the one of the candidate objects. At block 405c, the method 400c may include receiving, from the display, an indication of a touch gesture detected at or about the visual representation of the verify request. At block 407c, the method 400c may include determining that the detected touch gesture corresponds to the visual representation associated with the verification request. The method 400c may include verifying that the certain object is the one of the candidate objects based on the detected touch gesture, as represented by block 409c.

FIG. 4D illustrates another embodiment of a method 400d performed by a POS system 101, 200, 300a, 500 of object identification based on a partial visual object identifier code scan at point of sale in accordance with various aspects as described herein. In FIG. 4D, the method 400d may start, for instance, at block 401d where it may include receiving, from the second optical sensor, image data that represents an image of the certain object. At block 403d, the method 400d includes identifying the certain object based on the set of object identifiers, the image data, and that portion of the series of characters that represents the corresponding object identifier. The method 400d may include sending, to a network node over a network, an indication that includes a request to verify that the certain object corresponds to the one of the candidate objects based on the image data of the certain object, as represented by block 405d. At block 407d, the method 400d may include receiving, from the network node over the network, an indication that the certain object corresponds to the one of the candidate objects. The method 400d may include identifying the certain object based on the received indication, as represented at block 409d.

FIG. 4E illustrates another embodiment of a method 400e performed by a POS system 101, 200, 300a, 500 of object identification based on a partial visual object identifier code scan at point of sale in accordance with various aspects as described herein. In FIG. 4E, the method 400e may start, for instance, at block 401e where it may include receiving, from a load sensor of the POS system, an indication that includes a weight measurement of the certain object. At block 403e, the method 400e includes identifying the certain object based on that portion of the series of characters that represents the corresponding object identifier, the set of object identifiers, and the weight measurement. The method 400e may include determining that the measured weight of the certain object corresponds to a range of potential weights associated with one of the set of candidate objects, wherein each of the sets of objects has a certain range of potential weights, as represented by block 405e.

FIG. 5 illustrates another embodiment of a POS system 500 in accordance with various aspects as described herein. In FIG. 5, device 500 includes processing circuitry 501 that is operatively coupled over bus 503 to input/output interface 505, artificial intelligence circuitry 509 (e.g., neural network circuit, machine learning circuit), network connection interface 511, power source 513, memory 515 including random access memory (RAM) 517, read-only memory (ROM) 519 and storage medium 521, communication subsystem 531, and/or any other component, or any combination thereof.

The input/output interface 505 may be configured to provide a communication interface to an input device, output device, or input and output device. The device 500 may be configured to use an output device via input/output interface 505. An output device 561 may use the same type of interface port as an input device. For example, a USB port or a Bluetooth port may be used to provide input to and output from the device 500. The output device may be a speaker, a sound card, a video card, a display, a monitor, a printer, an actuator, a transducer 575 (e.g., speaker, ultrasound emitter), an emitter, a smartcard, another output device, or any combination thereof. The device 500 may be configured to use an input device via input/output interface 505 to allow a user to capture information into the device 500. The input device may include a touch-sensitive or presence-sensitive display 563, a first optical sensor 575 (e.g., a scanner), a second optical sensor 577 (e.g., camera), a load sensor 579 (e.g., weight sensor), a microphone, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical or image sensor, an infrared sensor, a proximity sensor, a microphone, an ultrasound sensor, another like sensor, or any combination thereof. As shown in FIG. 500, the input/output interface 505 can be configured to provide a communication interface to components of the terminal station device 102 such as the scanners 114, 116, a scale 114, the display device 118, touchscreen 118, the payment processing mechanism 122, the printer 124, the coupon slot mechanism 125, the cash acceptor mechanism 126, light emitting devices 130, keyboard, keypad, card reader, the like, or any combination thereof.

In FIG. 5, storage medium 521 may include operating system 523, application program 525, data 527, the like, or any combination thereof. In other embodiments, storage medium 521 may include other similar types of information. Certain devices may utilize all of the components shown in FIG. 5, or only a subset of the components. The level of integration between the components may vary from one device to another device. Further, certain devices may contain multiple instances of a component, such as multiple processors, memories, neural networks, network connection interfaces, transceivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In FIG. 5, the artificial intelligence circuitry 509 may be configured to learn to perform tasks by considering examples such as performing object detection, classification or identification. In one example, first artificial intelligence circuitry is configured to perform object detection or classification. Further, second artificial intelligence circuitry is configured to perform object identification as described herein. In FIG. 5, the network connection interface 511 may be configured to provide a communication interface to network 543a. The network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. The network connection interface 511 may be configured to include a receiver and a transmitter interface used to communicate with one or more other devices over a communication network according to one or more communication protocols, such as Ethernet, TCP/IP, SONET, ATM, or the like. The network connection interface 511 may implement receiver and transmitter functionality appropriate to the communication network links (e.g., optical, electrical, and the like). The transmitter and receiver functions may share circuit components, software or firmware, or alternatively may be implemented separately.

The RAM 517 may be configured to interface via a bus 503 to the processing circuitry 501 to provide storage or caching of data or computer instructions during the execution of software programs such as the operating system, application programs, and device drivers. The ROM 519 may be configured to provide computer instructions or data to processing circuitry 501. For example, the ROM 519 may be configured to store invariant low-level system code or data for basic system functions such as basic input and output (I/O), startup, or reception of keystrokes from a keyboard that are stored in a non-volatile memory. The storage medium 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, the storage medium 521 may be configured to include an operating system 523, an application program 525 such as web browser, web application, user interface, browser data manager as described herein, a widget or gadget engine, or another application, and a data file 527. The storage medium 521 may store, for use by the device 500, any of a variety of various operating systems or combinations of operating systems.

The storage medium 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. The storage medium 521 may allow the device 500a-b to access computer-executable instructions, application programs or the like, stored on transitory or non-transitory memory media, to off-load data, or to upload data. An article of manufacture, such as one utilizing a communication system may be tangibly embodied in the storage medium 521, which may comprise a device readable medium.

The processing circuitry 501 may be configured to communicate with network 543b using the communication subsystem 531. The network 543a and the network 543b may be the same network or networks or different network or networks. The communication subsystem 531 may be configured to include one or more transceivers used to communicate with the network 543b. For example, the communication subsystem 531 may be configured to include one or more transceivers used to communicate with one or more remote transceivers of another device capable of wireless communication according to one or more communication protocols, such as IEEE 802.11, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software, or firmware, or alternatively may be implemented separately.

In FIG. 5, the communication functions of the communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 531 may include cellular communication, Wi-Fi communication, Bluetooth communication, and GPS communication. The network 543b may encompass wired and/or wireless networks such as a local-area network (LAN), a wide-area network (WAN), a computer network, a wireless network, a telecommunications network, another like network or any combination thereof. For example, the network 543b may be a cellular network, a Wi-Fi network, and/or a near-field network. The power source 513 may be configured to provide alternating current (AC) or direct current (DC) power to components of the device 500a-b.

The features, benefits and/or functions described herein may be implemented in one of the components of the device 500 or partitioned across multiple components of the device 500. Further, the features, benefits, and/or functions described herein may be implemented in any combination of hardware, software, or firmware. In one example, communication subsystem 531 may be configured to include any of the components described herein. Further, the processing circuitry 501 may be configured to communicate with any of such components over the bus 503. In another example, any of such components may be represented by program instructions stored in memory that when executed by the processing circuitry 501 perform the corresponding functions described herein. In another example, the functionality of any of such components may be partitioned between the processing circuitry 501 and the communication subsystem 531. In another example, the non-computationally intensive functions of any of such components may be implemented in software or firmware and the computationally intensive functions may be implemented in hardware.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

In one exemplary embodiment, a method is performed by a POS system having a first optical sensor operable to scan visual object identifier codes disposed on objects. Each code represents one of a set of object identifiers, with each identifier being specific to a certain object and represented by a series of characters. The first optical sensor is positioned on or about the POS system so that a field of view of the first optical sensor is directed towards a certain region of the POS system associated with scanning the visual object identifier codes disposed on the objects. The method includes obtaining, based on a scan performed by the first optical sensor of one of the visual object identifier codes disposed on a certain object, a portion of the series of characters that represents a corresponding object identifier so that the certain object can be identified based on the portion of the series of characters that represents the corresponding object identifier and the set of object identifiers.

In another exemplary embodiment, the method further includes receiving, by a processing circuit of the POS system, from the first optical sensor, an indication that includes the portion of the series of characters that represents the corresponding object identifier.

In another exemplary embodiment, the method further includes identifying the certain object based on the portion of the series of characters that represents the corresponding object identifier and the set of object identifiers.

In another exemplary embodiment, the method further includes receiving, by a processing circuit of the POS system, from a second optical sensor of the POS system, image data that represents a captured image of the certain object. The second optical sensor is positioned on or about the POS system so that a field of view of the second optical sensor is directed towards a certain region of the POS system associated with capturing an image of an object while in that certain region. The method also includes identifying the certain object based on the portion of the series of characters that represents the corresponding object identifier, the set of object identifiers, and the image data of the certain object.

In another exemplary embodiment, the method further includes sending, by the POS system, to a network node over a network, an indication that includes a request to verify that the certain object corresponds to the one of the candidate objects based on the image data of the certain object. Further, the network node includes an artificial intelligence circuit operable to perform object identification so as to determine that the certain object corresponds to one of the candidate objects. The artificial intelligence circuit is trained on image data associated with the sets of objects. The method also includes receiving, by the POS system, from the network node over the network, an indication that the certain object corresponds to the one of the candidate objects. In addition, the method includes identifying the certain object as the one of the candidate objects based on the received indication.

In another exemplary embodiment, the method further includes receiving, by a processing circuit of the POS system, from a load sensor of the POS system, an indication that includes a weight measurement of the certain object. The method also includes identifying the certain object based on the portion of the series of characters that represents the corresponding object identifier, the set of object identifiers, and the weight measurement.

In another exemplary embodiment, the method further includes determining that the measured weight of the certain item corresponds to a range of potential weights associated with one of the set of candidate objects. Further, each of the sets of objects has a certain range of potential weights. The method further includes identifying the certain item as the one of the set of candidate objects.

In another exemplary embodiment, the method further includes determining those object identifiers of the set of object identifiers that correspond to the portion of the series of characters to obtain candidate object identifiers.

In another exemplary embodiment, the method further includes determining those object identifiers of the set of object identifiers that have the same characters in the same positions as the portion of the series of characters.

In another exemplary embodiment, the method further includes determining those object identifiers of the set of object identifiers that have the same characters in the same order as the portion of the series of characters.

In another exemplary embodiment, the method further includes determining those object identifiers of the set of object identifiers that correspond to the portion of the series of characters to obtain candidate object identifiers. The method also includes obtaining those objects that are specific to the candidate object identifiers to obtain the candidate objects. The method further includes outputting, for display on a presence sensitive display of the POS system, a visual representation associated with a request to select one of the candidate objects and then receiving, from the presence sensitive display, an indication of a touch gesture detected at or about the visual representation associated with one of the candidate objects. In addition, the method includes determining that the detected touch gesture corresponds to the one of the candidate objects. The method further includes identifying the certain object as the one of the candidate objects.

In another exemplary embodiment, the method further includes outputting, for display on a presence sensitive display of the POS system, a visual representation associated with a request to verify that the certain object is the one of the candidate objects. The method also includes receiving, from the presence sensitive display, an indication of a touch gesture detected at or about the visual representation associated with the verification request. The method further includes determining that the detected touch gesture corresponds to the visual representation associated with the verification request. In addition, the method includes verifying that the certain object is the one of the candidate objects.

In another exemplary embodiment, the portion of the series of characters includes characters at a first position and a last position of the series of characters. Further, one or more positions between the first and last positions of the series of characters corresponds to unscanned, undetected or undecoded characters of the series of characters.

In another exemplary embodiment, one or more positions that start at the first position or end at the last position of the series of characters corresponds to unscanned, undetected or undecoded characters of the series of characters.

In one exemplary embodiment, a POS system includes a first optical sensor operable to scan visual object identifier codes disposed on objects. Each code represents one of a set of object identifiers, with each identifier being specific to a certain object and represented by a series of characters. Further, the first optical sensor is positioned on or about the POS system so that a field of view of the first optical sensor is directed towards a certain region of the POS system associated with scanning the visual object identifier codes disposed on the objects. The POS system further includes a memory, with the memory containing instructions executable by the processing circuitry whereby the processing circuitry is configured to obtain, based on a scan performed by the first optical sensor of one of the visual object identifier codes disposed on a certain object, a portion of the series of characters that represents a corresponding object identifier so that the certain object can be identified based on the portion of the series of characters that represents the corresponding object identifier and the set of object identifiers.

In another exemplary embodiment, the memory includes further instructions executable by the processing circuitry whereby the processing circuitry is configured to identify the certain object based on that portion of the series of characters that represents the corresponding object identifier and the set of object identifiers.

In another exemplary embodiment, the POS system further includes a presence sensitive display. Also, the memory includes further instructions executable by the processing circuitry whereby the processing circuitry is configured to: determine those object identifiers of the set of object identifiers that correspond to the portion of the series of characters to obtain candidate object identifier; obtain those objects that are specific to the candidate object identifiers to obtain the candidate objects; output, for display on the presence sensitive display, a visual representation associated with a request to select one of the candidate objects; receive, from the presence sensitive display, an indication of a touch gesture detected at or about the visual representation associated with one of the candidate objects; determine that the detected touch gesture corresponds to the one of the candidate objects; and identify the certain object as the one of the candidate objects.

In another exemplary embodiment, the memory includes further instructions executable by the processing circuitry whereby the processing circuitry is configured to: determine those object identifiers of the set of object identifiers that correspond to the portion of the series of characters to obtain candidate object identifiers; obtain those objects that are specific to the candidate object identifiers to obtain the candidate objects; identify the certain object as the one of the candidate objects; output, for display on a presence sensitive display of the POS system, a visual representation associated with a request to verify that the certain object is the one of the candidate objects; receive, from the presence sensitive display, an indication of a touch gesture detected at or about the visual representation associated with the verification request; determine that the detected touch gesture corresponds to the visual representation associated with the verification request; and verify that the certain object is the one of the candidate objects.

In another exemplary embodiment, the POS system includes a second optical sensor operable to capture an image and positioned on or about the POS system so that a field of view of the second optical sensor is directed towards a certain region of the POS system associated with capturing an image of an object while in that certain region. Further, the memory includes further instructions executable by the processing circuitry whereby the processing circuitry is configured to: receive, from the second optical sensor, image data that represents a captured image of the certain object; and identify the certain object based on that portion of the series of characters that represents the corresponding object identifier, the set of object identifiers, and the image data.

In another exemplary embodiment, the POS system includes the load sensor operable to measure a weight of an object. Further, the memory includes further instructions executable by the processing circuitry whereby the processing circuitry is configured to: receive, from the load sensor, an indication that includes a weight measurement of the certain object; and identify the certain object based on the portion of the series of characters that represents the corresponding object identifier, the set of object identifiers, and the weight measurement.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein.

Alternatively or additionally, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method, comprising:
by a point of sale (POS) system having a first optical sensor operable to scan visual object identifier codes disposed on objects, with each code representing one of a set of object identifiers with each identifier being specific to a certain object and represented by a series of characters, with the first optical sensor being positioned on or about the POS system so that a field of view of the first optical sensor is directed towards a certain region of the POS system associated with scanning the visual object identifier codes disposed on the objects,
obtaining, based on a scan performed by the first optical sensor of one of the visual object identifier codes disposed on a certain object, a portion of the series of characters that represents a corresponding object identifier so that the certain object can be identified based on the set of object identifiers and the portion of the series of characters that represents the corresponding object identifier.

2. The method of claim 1, wherein the obtaining step includes:
receiving, by a processing circuit of the POS system, from the first optical sensor, an indication that includes the portion of the series of characters that represents the corresponding object identifier.

3. The method of claim 1, further comprising:
identifying the certain object based on the set of object identifiers and the portion of the series of characters that represents the corresponding object identifier.

4. The method of claim 1, further comprising:
receiving, by a processing circuit of the POS system, from a second optical sensor of the POS system, image data that represents a captured image of the certain object, with the second optical sensor being positioned on or about the POS system so that a field of view of the second optical sensor is directed towards the certain region of the POS system associated with scanning the visual object identifier codes disposed on the objects; and
identifying the certain object based on the set of object identifiers, the image data, and the portion of the series of characters that represents the corresponding object identifier.

5. The method of claim 4, wherein the identifying step further comprises:
sending, by the POS system, to a network node over a network, an indication that includes a request to verify that the certain object corresponds to the one of the candidate objects based on the image data of the certain object, wherein the network node includes an artificial intelligence circuit operable to perform object identification so as to determine that the certain object corresponds to one of the candidate objects, with the artificial intelligence circuit being trained on image data associated with the sets of objects;
receiving, by the POS system, from the network node over the network, an indication that the certain object corresponds to the one of the candidate objects; and
wherein the identifying step is further based on the received indication.

6. The method of claim 1, further comprising:
receiving, by a processing circuit of the POS system, from a load sensor of the POS system, an indication that includes a weight measurement of the certain object; and
identifying the certain object based on the portion of the series of characters that represents the corresponding object identifier, the set of object identifiers, and the weight measurement.

7. The method of claim 6, wherein the identifying step further comprises:
determining that the measured weight of the certain item corresponds to a range of potential weights associated with one of the set of candidate objects, wherein each of the sets of objects has a certain range of potential weights.

8. The method of claim 1, further comprising:
determining those object identifiers of the set of object identifiers that correspond to the portion of the series of characters to obtain candidate object identifiers.

9. The method of claim 8, wherein the object identifier determining step further comprises:
determining those object identifiers of the set of object identifiers that have the same characters in the same positions as the portion of the series of characters.

10. The method of claim 8, wherein the object identifier determining step further comprises:
determining those object identifiers of the set of object identifiers that have the same characters in the same order as the portion of the series of characters.

11. The method of claim 1, further comprises:
determining those object identifiers of the set of object identifiers that correspond to the portion of the series of characters to obtain candidate object identifiers;
obtaining those objects that are specific to the candidate object identifiers to obtain the candidate objects;
outputting, for display on a presence sensitive display of the POS system, a visual representation associated with a request to select one of the candidate objects;
receiving, from the presence sensitive display, an indication of a touch gesture detected at or about the visual representation associated with one of the candidate objects;
determining that the detected touch gesture corresponds to the one of the candidate objects; and
identifying the certain object as the one of the candidate objects.

12. The method of claim 11, further comprising:
outputting, for display on a presence sensitive display of the POS system, a visual representation associated with a request to verify that the certain object is the one of the candidate objects;
receiving, from the presence sensitive display, an indication of a touch gesture detected at or about the visual representation associated with the verification request;
determining that the detected touch gesture corresponds to the visual representation associated with the verification request; and
verifying that the certain object is the one of the candidate objects.

13. The method of claim 1, wherein the portion of the series of characters includes characters at a first position and a last position of the series of characters, with one or more positions between the first and last positions of the series of characters corresponding to unscanned, undetected or undecoded characters of the series of characters.

14. The method of claim 1, wherein one or more positions that start at the first position or end at the last position of the series of characters corresponds to unscanned, undetected or undecoded characters of the series of characters.

15. A point of service (POS) system, comprising:
with the POS system having a first optical sensor operable to scan visual object identifier codes disposed on objects, with each code representing one of a set of object identifiers with each identifier being specific to a certain object and represented by a series of characters, with the first optical sensor being positioned on or about the POS system so that a field of view of the first optical sensor is directed towards a certain region of the POS system associated with scanning the visual object identifier codes disposed on the objects,
wherein the POS system further includes a memory, the memory containing instructions executable by the processing circuitry whereby the processing circuitry is configured to:
obtain, based on a scan performed by the first optical sensor of one of the visual object identifier codes disposed on a certain object, a portion of the series of characters that represents a corresponding object identifier so that the certain object can be identified based on the set of object identifiers and the portion of the series of characters that represents the corresponding object identifier.

16. The POS system of claim 15, wherein the memory includes further instructions executable by the processing circuitry whereby the processing circuitry is configured to:
identify the certain object based on the set of object identifiers and that portion of the series of characters that represents the corresponding object identifier.

17. The POS system of claim 15, wherein the POS system further includes a presence sensitive display; and
wherein the memory includes further instructions executable by the processing circuitry whereby the processing circuitry is configured to:
determine those object identifiers of the set of object identifiers that correspond to the portion of the series of characters to obtain candidate object identifiers;
obtain those objects that are specific to the candidate object identifiers to obtain the candidate objects;
output, for display on the presence sensitive display, a visual representation associated with a request to select one of the candidate objects;
receive, from the presence sensitive display, an indication of a touch gesture detected at or about the visual representation associated with one of the candidate objects;
determine that the detected touch gesture corresponds to the one of the candidate objects; and
identify the certain object as the one of the candidate objects.

18. The POS system of claim 15, wherein the memory includes further instructions executable by the processing circuitry whereby the processing circuitry is configured to:
determine those object identifiers of the set of object identifiers that correspond to the portion of the series of characters to obtain candidate object identifiers;
obtain those objects that are specific to the candidate object identifiers to obtain the candidate objects;
identify the certain object as the one of the candidate objects;
output, for display on a presence sensitive display of the POS system, a visual representation associated with a request to verify that the certain object is the one of the candidate objects;
receive, from the presence sensitive display, an indication of a touch gesture detected at or about the visual representation associated with the verification request;
determine that the detected touch gesture corresponds to the visual representation associated with the verification request; and
verify that the certain object is the one of the candidate objects.

19. The POS system of claim 15, wherein the POS system includes a second optical sensor operable to capture an image and positioned on or about the POS system so that a field of view of the second optical sensor is directed towards the certain region of the POS system associated with scanning the visual object identifier codes disposed on the objects; and
wherein the memory includes further instructions executable by the processing circuitry whereby the processing circuitry is configured to:
receive, from the second optical sensor, image data that represents a captured image of the certain object; and
identify the certain object based on that portion of the series of characters that represents the corresponding object identifier, the set of object identifiers, and the image data.

20. The POS system of claim 15, wherein the POS system includes the load sensor operable to measure a weight of an object; and
wherein the memory includes further instructions executable by the processing circuitry whereby the processing circuitry is configured to:
receive, from the load sensor, an indication that includes a weight measurement of the certain object; and
identify the certain object based on the portion of the series of characters that represents the corresponding object identifier, the set of object identifiers, and the weight measurement.
